(19) United States
(12) Patent Application Publication
(10) Pub. No.: US 2010/0031237 A1
(43) Pub. Date: Feb. 4, 2010

(54) Methods for Detecting Inter-Module Dependencies

(75) Inventor: Aviad Zlotnick, Mitzpeh Netofah (IL)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/184,294

(22) Filed: Aug. 1, 2008

(51) Int. Cl. G06F 9/44

(52) U.S. Cl. 717/121

(57) ABSTRACT

Methods for detecting inter-module dependencies involve receiving by a software configuration control system check-in for each of a plurality of software components accompanied by check-in information consisting at least in part of defect information, which is utilized to identify coupling between any of the checked-in software components that were checked in together on a same defect and any of the checked-in software components that were checked in on a defect that was introduced by a defect in another software component. Warnings and reports are generated of a likely incidence of coupling between any of the software components identified as having been checked in together on a same defect, as well as between any of the software components identified as having been checked in on a defect that was introduced by a defect in another software component and such other software component.

### BACKGROUND OF THE INVENTION

1. Field of the Invention

This invention relates to configuration control software and more particularly to methods for detecting inter-module dependencies using configuration control software.

2. Description of Background

In the process of writing software systems, the systems have parts which are referred to as modules that are ideally independent of one another. When the respective parts of a system are not independent, there is said to be “coupling” between them. Coupling is a kind of dependence, for example, such that Module A will not work correctly unless Module B does something specific.

Coupling between software modules is considered harmful. In addition to exposing unclear thinking during design, coupling causes problems in maintenance. If there is coupling between two modules, and one is modified at some time, there is a significant likelihood that the other module will also need to be changed. However, the other module will not be changed because the person introducing the change in the first module is not aware of the dependency between the modules.

Coupling is distinguished, for example, from the application programming interface (“API”) that exists between the modules, i.e., what Module B does for Module A for which Module A is dependent on Module B, such as calculating a square root by Module B on which Module A depends. That is referred to as the external interface. However, if Module A depends on anything internal to Module B, there is undesirable coupling between the two modules, and such undesirable coupling is usually not disclosed. Therefore, when maintenance is performed on either Module A or Module B, the coupling is likely to cause breakage.

Although the best solution to inter-module dependency is to avoid it, reality shows that such dependencies do exist. Assume, for example, that Module B which computes the square root on which Module A uses temporary storage that must be allocated by Module A. In programming language, assume that this is a global variable that is thus not passed as an interface to Module B. When the program is read and one sees that Module B is calculating a square root, it is deemed to be a good thing, but when one then sees this global variable, it may be deemed unnecessary and removed, whereupon Module B stops working.

Thus, it is apparent that such undeclared dependence between two modules is not usually a good thing. In some cases, the dependence between modules can be in the way something is implemented. For example, things can be in a linked list or in an array, and using the modules one should not care how the service provider is implementing whatever service it is providing. In any event, the general rule is that the less coupling there is between modules, the better the situation is. If it is necessary to have coupling between modules, it is preferable to have the coupling clearly stated in the interface between the two modules.

It is therefore important to know where there is coupling in particular software so that it can be cleaned out. This could be an indication for refactoring existing code or even entirely rewriting the code. On the other hand, in maintaining code and introducing fixes, it may be necessary to know what is coupled to the code in order to avoid violating the requirements of the coupling. Thus, referring again to the foregoing example, before getting rid of the global variable that B uses as temporary storage, knowledge of the existence of the strong coupling between Module A and Module B brings awareness that one must be careful not to introduce a bug from ignorance of the particular coupling.

It is possible to discover the existence of coupling between modules, for example, by running various kinds of static analysis and having the code analyzed, which can turn up dependencies that are clear in the syntactic level. Such analysis can be very time and resource intensive and may still not yield a suitable result.

### SUMMARY OF THE INVENTION

The shortcomings of the prior art are overcome and additional advantages are provided through embodiments of the invention proposing methods for detecting inter-module dependencies that involve, for example, receiving check-in by a software configuration control system for each of a plurality of software components (e.g., files, functions, block, class, or directory level) accompanied by entry of check-in information for each of the checked-in software components consisting at least in part of defect identification. The defect identification is utilized to identify coupling of any of the checked-in software components that were checked in together on a same defect and any of the checked-in software components that were checked in on a defect that was introduced by a defect in another software component.

According to embodiments of the invention, a warning is generated of a likely incidence of coupling between any of the software components identified as having been previously checked in together on a same defect and a warning is likewise generated of a likely incidence of coupling between any of the software components identified as having been previously checked in on a defect that was introduced by a defect in another software component and such other software component. Periodically, or on demand, a report is also generated that lists each of the software components that was identified as having been checked in together on the same defect and of each of the software components that was identified as having been checked in on a defect that was introduced by a defect in another software component.

### Technical Effects

As a result of the summarized invention, technically we have achieved a solution for implementing methods for detecting inter-module dependencies in which inter-module dependencies are detected using configuration control system records.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow chart that illustrates an example of the process of detecting inter-module dependencies for embodiments of the invention.

The detailed description explains the preferred embodiments of the invention, together with advantages and features, by way of example with reference to the drawings.

### DETAILED DESCRIPTION OF THE INVENTION

Embodiments of the invention propose a method for detecting existing inter-module dependencies. Once such dependencies are known, it is possible to modify the design to remove the dependencies or at least to produce a warning when one module is changed and one or more other modules depending on it are not changed.

A core idea of embodiments of the invention is to use configuration control records to detect coupling between modules. Specifically, two features that exist in configuration control systems can be used.

A first such feature is that when files are checked in together (using the same defect or track), one can assume that they are coupled to some degree. When this check-in is not the first such check-in for these files, but rather after a modification, the coupling assumption can be focused to the location of the modifications.

When using a configuration control system, one identifies a defect, for example, with a defect identification number. When checking in two files, one typically specifies a reason for checking the files in, such as the two files were be modified for Defect D. For example, assume that a customer's system crashes, in which case a complaint is opened and the problem is identified as Defect D. The problem is then analyzed and a determination is made that in order to fix the problem identified as Defect D, it is necessary to modify Module A in File X and Module B in File Y. These two files are then checked out from the configuration management system and modified, whereupon they are checked back in with the reason identified, for example, as “These files are checked back in for the sake of Defect D.

Thus, checking the two files back in with such identification is indicative that the two files have a dependency between them, because both have to change for a single defect. In other words, when two files are checked in together using the same defect or track identification, it can be assumed that there is at least some degree of coupling between the files.

A second such feature is that when checking in a fix, some processes require developers to specify which previous check-in produced the problem. In cases when the previous check-in was not of the same file or function, a clear indication of dependency exists.

Assume, for example, that on a first occasion, Defect D in File X was fixed, and on a subsequent occasion, a new Defect E in File Y arises which when fixed is discovered to have resulted from changes that were made on the first occasion to fix Defect D in File X. A typical configuration control system my pose a question, such as “When was the defect introduced?” to which the response would be that the Defect E in File Y was introduced by fixing Defect D in file X. Such a response is likewise indicative that there is a dependency between the Files X and Y fixed for Defects D and E. In other words, it can likewise be assumed from the existence of such a statement that there is at least some degree of coupling between the files.

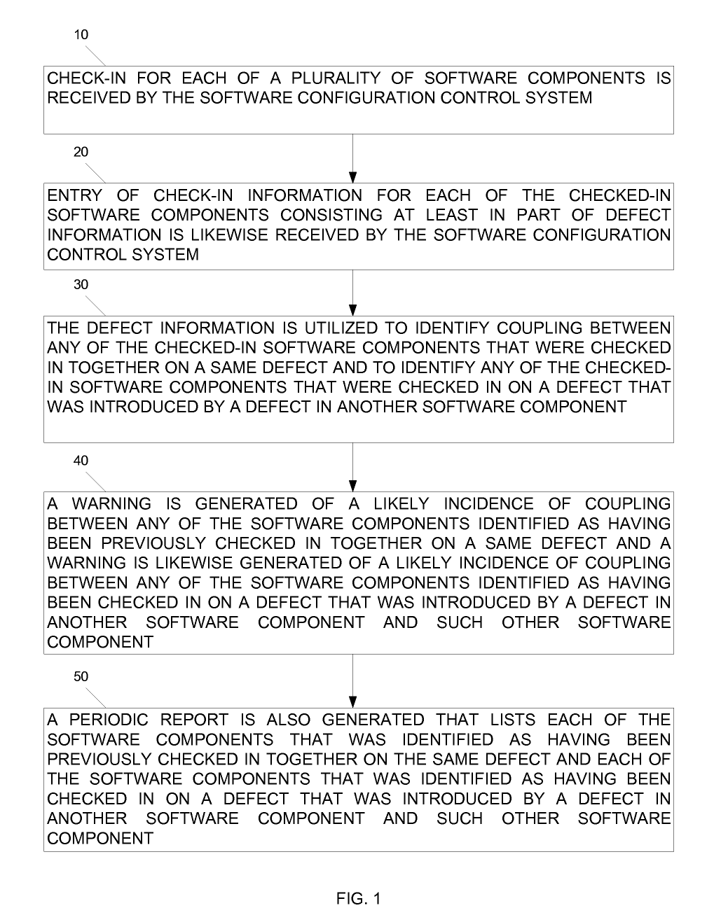

FIG. 1 is a flow chart that illustrates an example of the process of detecting inter-module dependencies for embodiments of the invention. Referring to FIG. 1, at 10, check-in for each of a plurality of software components is received by the software configuration control system, and at 20, entry of check-in information for each of the checked-in software components consisting at least in part of defect information is likewise received. At 30, the defect information is utilized to identify coupling between any of the checked-in software components that were checked in together on a same defect and any of the checked-in software components that were checked in on a defect that was introduced by a defect in another software component.

Referring further to FIG. 1, at 40, a warning is generated of a likely incidence of coupling between any of the software components identified as having been previously checked in together on a same defect and a warning is likewise generated of a likely incidence of coupling between any of the software components identified as having been previously checked in on a defect that was introduced by a defect in another software component and such other software component. At 50, a periodic report is also generated that lists each of the software components that was identified as having been checked in together on the same defect and of each of the software components that was identified as having been checked in on a defect that was introduced by a defect in another software component.

In addition to dependencies between files, embodiments of the invention can also be used to detect dependencies between functions in files. For example, a file can be a sort for 15 functions or 1,500 functions and the configuration control system knows exactly where the fix was made. Thus it can be concluded that a particular function or functions are dependent on another particular function or functions. This is true between functions in different files or between functions within the same file.

The confidence in the inter-module dependencies found by using configuration control records according to embodiments of the invention increases when indications of coupling repeat. Accordingly, a threshold on the number of repetitions can be used to reduce the number of false alarms. While it can be assumed when two files are checked in together using the same defect or track identification that there is at least some degree of coupling between the files, an aspect of embodiments of the invention involves, for example, counting the number of occurrences of such check-ins and withholding the determination and/or issuance of a warning that the files are coupled until a pre-determined number of such check-ins have occurred.

In embodiments of the invention, the information about inter-module dependency can be utilized to assess the quality of existing software and to prevent bugs that result from ignorance of the dependencies. Both of these uses can be incorporated into configuration control tools, as reports and warnings respectively. According to embodiments of the invention, coupling information detected by utilizing the configuration management system can be collected and eventually used to generate a report on all the couplings within a particular system and marking ones with the highest degree of dependency for refactoring, i.e., rewriting the code to perform the same function but with a better coding quality.

Further, if someone checks in a change to a File or Function X and strong coupling to File or Function Y was detected utilizing the configuration management system according to embodiments of the invention, a warning can be issued, such as “Dear developer, please be aware that File or Function Y is strongly coupled to File or Function X; make sure that you did not overlook something.”

Implementation of embodiments of the invention is straightforward and depends on specifics of configuration control software. In addition to files and functions, dependencies addressed include, for example, block, class, or directory level. Once a file is checked in, the location of the change can be identified, and the coupling defined at any desired level.

The flow diagrams depicted herein are only examples. There may be many variations to these diagrams or the steps (or operations) described therein without departing from the spirit of the invention. For example, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer-implemented method for detecting inter-component dependencies using software configuration control records, comprising:
receiving check-in by a software configuration control system for each of a plurality of software components;
receiving entry by the software configuration control system of check-in information for each of said checked-in software components consisting at least in part of defect information;
identifying from the defect information a coupling or property of any of said checked-in software components that were checked in together on a same defect and any of said checked-in software components that were checked in on a defect that was introduced by a defect in another software component;
generating a warning of a likely incidence of coupling between any of said software components identified as having been previously checked in together on a same defect upon an occurrence of a pre-determined threshold number of repetitions of said software components being identified as having been previously checked in together on said same defect and a likely incidence of coupling between any of said software components identified as having been previously checked in on a defect that was introduced by a defect in another software component and such other software component upon an occurrence of a pre-determined threshold number of repetitions of said software components being identified as having been previously checked in on said defect that was introduced by said defect in another software component; and
periodically generating a report listing each of said software components identified as having been checked in together on the same defect and of each of said software components identified as having been checked in on a defect that was introduced by a defect in another software component and such other software component.
